(19) United States
(12) Patent Application Publication
(10) Pub. No.: US 2004/0108223 A1
(43) Pub. Date: Jun. 10, 2004

(54) Simplified signal processing method for voltammetry

(76) Inventor: Rasmus Jansson, Linkoping (SE)

Correspondence Address: YOUNG & THOMPSON, 745 SOUTH 23RD STREET 2ND FLOOR, ARLINGTON, VA, 22202

(21) Appl. No.: 10/320,539

(22) Filed: Dec. 17, 2002

(30) Foreign Application Priority Data
Dec. 9, 2002 (SE) 02 03661-4

(51) Int. Cl. G01N 27/26

(52) U.S. Cl. 205/775; 204/400

(57) ABSTRACT

A method of signal processing for voltammetry is based on the customizing of a univariate mathematical model for an extracted feature of a selected and preprocessed subset of a response signal, obtained from the system under study. The extracted feature is used as input to the model. Optionally, several such models from different selected parts of the response can be combined. To generate a response, a voltage function is applied to a voltammetric system. The current response from the system is registered.

### FIELD OF THE INVENTION

The present invention relates generally to the analysis of components in liquids by voltammetric methods, in particular as applied to electronic tongues.

### BACKGROUND OF THE INVENTION

An ideal, selective sensor is only sensitive to one physical property or chemical compound. This is the preferable sensor type when one wants to measure a specific, pre-defined quality, such as pH, conductivity, or light intensity. Non-selective sensors, on the other hand, respond to more than one stimulus and thus give ambiguous information by themselves. In reality, few sensors are completely selective (reacting to only one stimulus) and none is totally non-selective (reacting to all stimuli). Still, these terms are used to describe sensors with high and low selectivity, respectively.

However, by combining the readings of many non-selective sensors, each with different response properties or chemical preferences, a complex pattern or ‘fingerprint’ can be obtained that contains information not easily measurable by selective sensors. In its general form, the electronic tongue is such a non-selective system.

Non-selective sensors are particularly useful when the variables of the measurement either are not known beforehand or are difficult to measure directly with existing, selective sensors. One drawback is that the use of non-selective sensors have required the use of more advanced mathematical tools for data processing.

The two most common principles employed for electronic tongues are potentiometry and voltammetry. In potentiometry, the voltage over a charged membrane is measured. In voltammetry, a predefined voltage function—typically a step function with different amplitudes, positive and/or negative—is applied between a catalytically active working electrode and a counter electrode. Optionally a reference electrode can be used. Depending on the electrochemical properties of the conducting medium and the electrode, the voltage causes a specific current response which is measured. The result is a characteristic response profile for the measured medium.

There are many possibilities in selecting voltage functions for the electronic tongue. The most common functions are called SAPV and LAPV, short for Small and Large Amplitude Pulse Voltammetry, respectively. The SAPV step function resembles a staircase, whereas the characteristic property for a LAPV step function is that the voltage is reduced to zero in between the pulses (see e.g. WO 99/13325).

In a further development of these voltage pulse functions, a voltage function, referred to as the SUPERLAPV, has been disclosed in SE 0104006-2, where the voltage oscillates between positive and negative amplitudes. By virtue of the switching polarity of the SUPERLAPV, it makes possible much larger step-to-step voltage differences than can be obtained with SAPV and twice that of LAPV. SUPERLAPV has been shown to be superior to the other two voltage functions (SAPV and LAPV) for measuring the redox activity of urea, probably because this activity is not as easily triggered by the smaller voltage oscillations of SAPV and LAPV.

In said SE 0104006-2 there is also disclosed an electronic tongue embodying the SUPERLAPV function. The system disclosed therein is in the form of an electronic tongue, and basically consists of an electrode unit, suitably but not necessarily comprising a plurality of electrodes, e.g. four electrodes. A tubular housing in which the four working electrodes are located, in an insulating matrix material, constitutes the counter electrode. The electronic tongue further comprises a potentiostat (signal generator), a signal measurement unit, and a PC (or a suitable microprocessor) for data processing. Thus, the term “electronic tongue”, as used in said application, and also as it is used in the present application, refers rather to the entire system than to the actual sensor unit.

The signals obtained from the electronic tongue when operated according to any of the functions mentioned above, are mathematically treated by employing multivariate analysis.

This kind of voltammetry is disclosed i.a. in said WO 99/13325, see e.g. page 8, lines 1-9, and claims 1-5.

However, multivariate analysis comprises advanced algorithms and heavy matrix algebra. It also requires a complicated and non-transparent procedure of training the electronic tongue system to recognize characteristics of the analyte system on which the measurement method is to be applied.

### SUMMARY OF THE INVENTION

Therefore, the object of the present invention is to provide a simplified procedure for measurements on complex analyte systems using an electronic tongue based on voltammetry, where one can refrain from mathematically complicated multivariate analysis.

This object is achieved with a method according to claim 1.

Thus, there is provided a method of signal processing for voltammetry, comprising applying a voltage function to a voltammetric system; registering a current response from said system; selecting at least one subset of said current response; preprocessing the selected subset to extract a feature; customizing a univariate mathematical model for the extracted feature of the selected and preprocessed subset of the response signal, using said feature as input to the model; optionally combining several such models from different selected parts of the response; and evaluating the model to obtain the final output.

Examples of liquids that can be analyzed are any electrolyte diverted from the vascular system of a patient, such as blood, dialysate, urine, gastric liquids, and lymphatic liquids. An example from a different field is ozone dissolved in water. Thus no liquids are excluded per se.

The measurement system is defined in claim 9, and is based on a voltammetric electronic tongue, the response of which is analyzed by the novel method as defined in claim 1.

It should be noted that data is usually preprocessed before entering a multivariate model building, so the relative lack of complexity of the procedures according to the present invention should be compared to the complexity of the multivariate model building including the preprocessing. The advantage of the present invention is thus the relatively speaking lower degree of complexity

By virtue of the fact that the present system is an on-line, real-time monitoring system, it is very well adapted for automatic control of the status of a treatment, such as dialysis. Thus, in one embodiment of the system there is provided for a continuous output of concentration values of the analyte under observation, e.g. urea, onto a display, in the form of a graph that gives a visual and readily comprehensible indication of the progress of the treatment. Thereby, the physician or nursing or operating staff by graphically monitoring the measurements in real-time, can easily determine when treatment has reached a point where it can be stopped.

Another way of signalling when the treatment has been completed is in a further embodiment the provision of an indicator lamp shining red as long as a predetermined level of the analyte has not been reached, and as soon as the set value is reached, it can turn green, indicating complete treatment.

### BRIEF DESCRIPTION OF THE DRAWINGS

The invention will be described below with reference to the drawings, in which

FIG. 1 shows examples of step functions SAPV, LAPV, and SUPERLAPV, respectively.

FIG. 2 shows k-values plotted in same plot as the reference values before translation and scaling.

FIG. 3 shows translated k-values plotted in same plot as the reference values before scaling. The translation constant k0 is responsible for the calibration and can be calculated automatically before each measurement series as the offset of the, say, 10 first k-values.

FIG. 4 shows translated and scaled k-values plotted in the same plot as the reference values. The scaling constant a, in this case a=75, must in this modelling approach be optimized and determined for the training data set. This constant will be used for all subsequent measurements.

FIG. 5 shows test set predictions with the chosen model constant a=75. Average error of prediction (RMSEP) was 0.56 ppm. The test set is three times as large as the training set.

FIG. 6 shows test set predictions using a multivariate PLS model. Average error of prediction (RMSEP) was 0.62 ppm. This plot is included as a reference.

FIG. 7 shows an electronic tongue system usable with the invention.

FIG. 8 is a flow chart of the method according to the invention.

### DETAILED DESCRIPTION OF PREFERRED EMBODIMENTS OF THE INVENTION

The method and system according to the invention is based on the use of a kind of sensor referred to as an electronic tongue, and which is based on voltammetry. The non-selectivity of this sensor technology generates large amounts of data which normally, i.e. according to prior art, will be interpreted using multivariate methods.

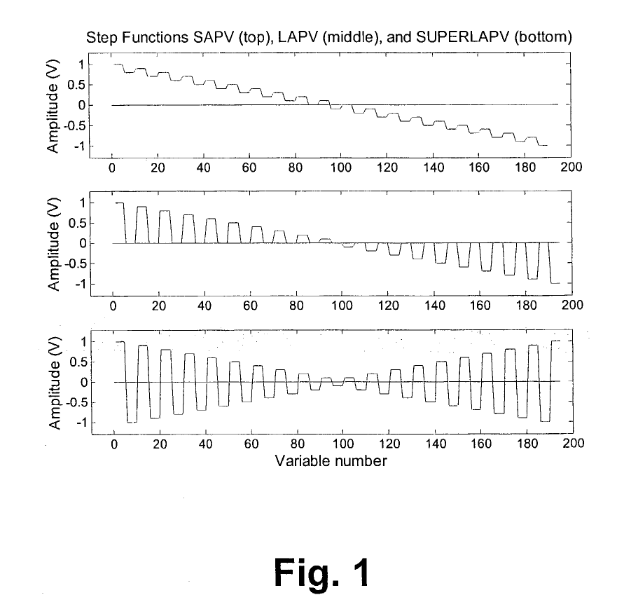

As indicated in the Background section, there are many possibilities in selecting voltage functions for the electronic tongue. An example of each of the mentioned step functions is shown in FIG. 1. On the other hand, it should be understood that the present invention is applicable in a general sense to virtually any voltage function. Sine functions or “saw-tooth” functions can be mentioned as possible alternatives.

However, for the purpose of this invention the expression “voltage function” excludes a voltage that is constant over the entire measurement interval.

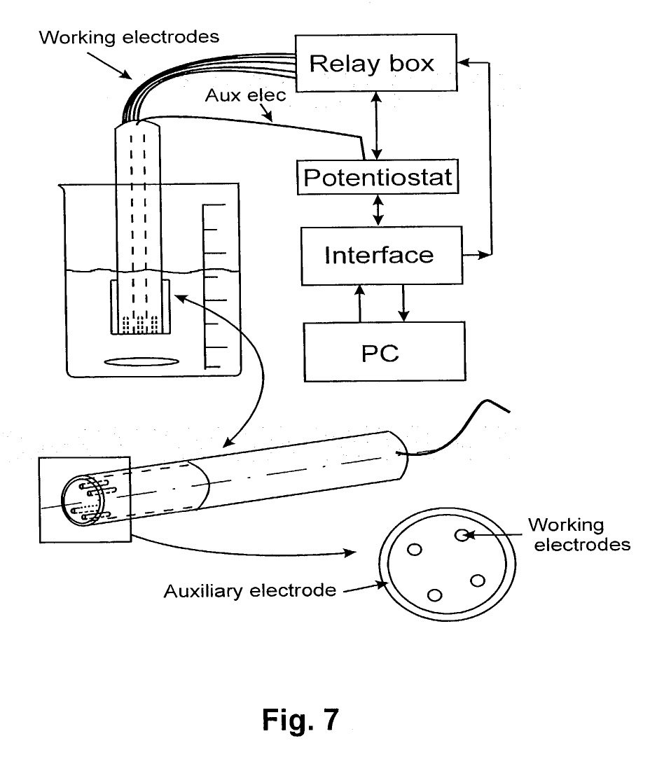

FIG. 7 shows a schematic picture of an electronic tongue usable with the invention.

Thus, the illustrated system in the form of an electronic tongue, basically consists of an electrode unit, suitably but not necessarily comprising a plurality of electrodes, in the shown embodiment four electrodes. As shown, the tubular housing in which the four working electrodes are located, in an insulating matrix material, constitutes the counter electrode. The electronic tongue further comprises a potentiostat and a PC (or a suitable microprocessor) for data processing.

The sensor unit is immersed in a sample liquid in a suitable vessel, which could be of metal and serve as a counter electrode if the sensor body in which the electrodes are embedded is made entirely of an insulating material.

The potentiostat can be conventional and will not be discussed further herein. For the purpose of this application and invention, the expression “voltammetric system” should be taken to encompass an analyte in a liquid, e.g. ozone in water, and the equipment required and used for carrying out the measurements.

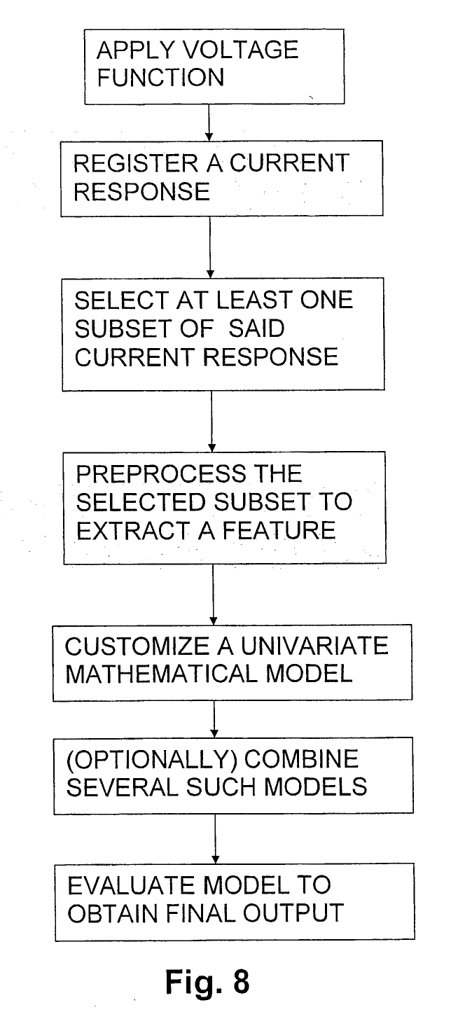

In general terms (shown in a flow chart in FIG. 8), the method according to the invention comprises applying a voltage function to a voltammetric system. The current response from said system is registered, and at least one subset of said current response is selected. Then, the selected subset is preprocessed to extract a feature. A univariate mathematical model for the extracted feature of the selected and preprocessed subset of the response signal is customized, using said feature as input to the model. Optionally, several such models from different selected parts of the response are combined, and finally the model is evaluated to obtain the final output.

Now the mathematical model on which the invention is based will be described.

Thus, Equation (1) below defines the actual concentration C measured in a voltammetric system as a function of a set of data points X obtained from a voltammetric measurement performed with an electronic tongue of the type described above.

$$C ( X ) = {\sum }_{i = 1}^{n} {w}_{i} \cdot {f}_{i} ( {g}_{i} ( X ) ) \qquad ( 1 )$$

In this equation the various symbols have the following meaning:

X=vector of raw data from a measurement

each i denotes a class of sample data from the current response obtained form the applied voltage function (e.g. sine wave, saw-tooth, pulse train etc).

By the term “class” we mean i) a particular selection of points from the current response and ii) the manner by which said data points in the response selection are treated/preprocessed.

For a pulse function one can consider as an example a voltage function in the form of a pulse train of four pulses alternating in amplitude 1V, 2V, 1V, 2V. One class can be pulses with amplitude 1V for which a feature of the entire response curve is considered, such as the average slope. A second class can be the same selection of pulses but for which only a portion of the response curve is considered, such as the amplitude of the redox current towards the end of each pulse. Still another class can consist of the pulses having amplitude 2V for which only the mid point of the response is considered, and so on.

gᵢ is a function and/or filter that selects a class i from the current response and pre-treats the data such that the desired feature is extracted. Here “function” and “filter” refer to software and hardware preprocessing, respectively.

This implies that different gᵢ's can extract different information from one and the same pulse.

fᵢ is a function that correlates the feature (its value) selected by gᵢ to the concentration of the analyte in the sample. As an example, consider a linear univariate model fᵢ=b*kᵢ+c. Herein kᵢ=gᵢ(x) is the average slope of the current response corresponding to pulses having a certain amplitude. This example directly generalizes to considering the integral or the amplitude instead of the slope; gᵢ(x)=Iᵢ or gᵢ(x)=Aᵢ, each symbolizing the integral and the amplitude of data subset i respectively, could be equally well suited. Note that a certain gᵢ may extract a subset of points corresponding to a part of the voltage function that is constant in the interval of interest for gᵢ, despite the fact that the voltage function is not constant over the entire measurement interval.

Another example is fᵢ=(gᵢ(x)−p0)^{0.8} where p0 is a parameter that is obtained by an automatic calibration measurement, and the exponent 0.8 is a weak non-linearity between the extracted feature and C.

For a voltage pulse function, when several pulses are used, the proviso is that for a given i, pulses of the same amplitude can be selected, in order to form an average to reduce noise.

n=number of terms in the sum, i.e. the number of classes or selections, according to the definition above.

Consider, as an example, the pulse train 0 1 2 1 −3 0 2 1 2 −3 0 −3 0, which would give n=3, if the zeroes are disregarded. However, also the zeroes could contain information, and if considered, this would make n=4. This assumes, of course, that there is valuable information in all pulses to be obtained, without which the less contributing pulse type(s) would be discarded. Hence n=1 ideally, which could be the case if the system retains good-enough performance despite such a simplification.

Σ is a sum where i is from 1 to n

C=concentration function, scalar output, i.e. the measured concentration.

The model building process of the method according to the present invention consists of considering each selected part of the pulse train separately, and performing separate training of each function fᵢ. This training of fᵢ is typically univariate after the preprocessing of X has been done, i.e. by the gᵢ functions or filter.

The invention will now be further illustrated by way of example.

### EXAMPLES

### Example 1 (Hypothetical)

Assuming that, for a particular application (e.g. ozone in water), the concentration information is approximately linear and lies in the slope k of the positive pulse average, a simple mathematical model (i.e. a univariate formula) of the concentration C can be created: C(k)=a*k+b, where a and b are constants. In principle, calibration and training of the model then merely consists in finding the constants a and b. See below for a practical example.

The procedure above easily generalizes to any number of pulse trains in succession, where each is treated separately and their outputs are weighted together. For example, two such pulse trains in succession, say 0, 2, 0, 2, . . . , 0, 2, 0, 1, 0, 1, . . . , 0, 1, 0 V, could be treated in the following way: C1(k1)=a1*k1+b1 and C2(k2)=a2*k2+b2, where k1 is the slope for the 1 V pulses and k2 for the 2 V pulses. The final concentration could then be calculated according to C(k1,k2)=1/2*(C1(k1)+C2(k2)), or by any other weighting procedure. Nestled pulse trains, say for example 0, 2, 1, 2, 1, 2, 1, 0 V, could be treated analogously by first averaging the readings of all the 2 V pulses, then of the 1 V pulses, and then build separate models for each amplitude and weight their outputs together. Another possibility within the same framework is to look at different parts of one response pulse separately. Supposing we have the pulse train 0, 1, 0, 1, 0, 1, 0 V, after averaging the 1 V pulses we could for example consider the slope of the first half of the pulse separately from the second.

The purpose of averaging over several identical pulses is only to reduce noise and increase sensor stability by redundancy.

The essential contribution of the invention is thus to be seen in the principle of customizing a relatively simple mathematical model for a selected part of the response signal, and, if desired or necessary, combine several such models from different selected parts of the response to obtain the final output.

By treating each selected part of the response signal separately, the mathematical modelling can be vastly simplified in comparison with multivariate methods, which comprises advanced algorithms and heavy matrix algebra. This new voltammetric signal treatment principle has two major advantages: Firstly, the implementation of the invention in a microprocessor environment becomes simpler and thus potentially cheaper. Secondly, the traditional, relatively low-level mathematics involved in the invention, as opposed to the more cumbersome multivariate methods, renders the technology more transparent and easily understood by scientists, industrial partners, customers, etc.

### Example 2 (Ozone in Water)

Following the procedure proposed above, calibration of a model can be done in the following way (the presented results are based on real laboratory data from voltammetric measurements of the concentration of ozone in water solutions).

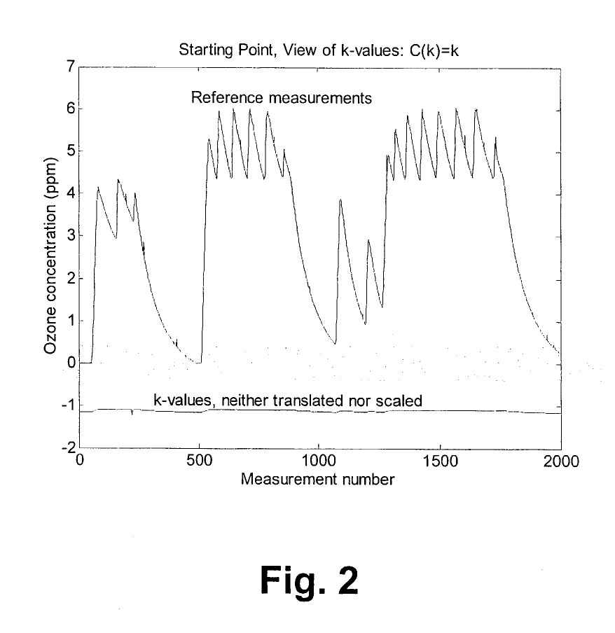

1. A pulse train of oscillating amplitude, 2, −2, . . . , 2, −2 V is applied between the electrodes and the resulting pulse responses are sampled in two points per pulse, in the beginning and at the end. The average slopes for the positive pulse responses are calculated for each measurement (the negative are omitted for simplicity). These average slopes k are plotted in the same graph as the reference instrument's readings, see FIG. 2. The reference instrument's readings can be considered the “goal” function of this calibration, as we want to manipulate the readings of k to be transformed into these concentration values. Equation-wise, we now have C(k)=k.

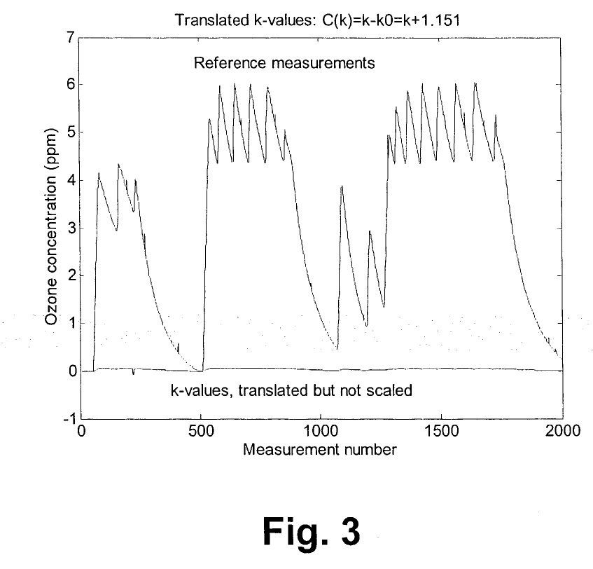

2. During the first10 measurements the ozone level is kept at 0 ppm (just plain water) to allow one of the two calibration constants to be calculated automatically. This bias is subtracted from all values of k, see FIG. 3, which causes a translation of the entire k-curve to start at zero. Equation-wise, we now have C(k)=k−k0, where k0 is the value of k at the concentration 0 ppm. Note that this bias term k0 is easily calculated automatically by a microprocessor, for example as the average k over the first m measurements. Because of this, k0 can be considered as a parameter to be measured and is thus not to be preset in the mathematical modelling.

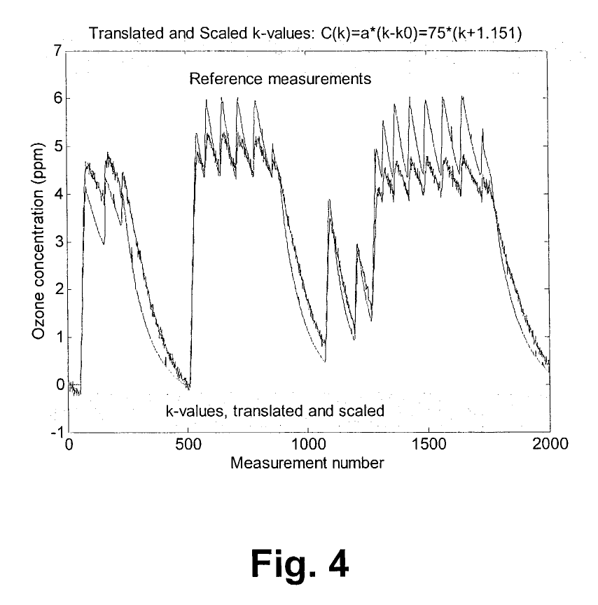

3. After the translation performed above, all that remains is to scale the k-curve to its optimal fit to the reference signal curve. This scaling can be done “by hand”, as has been done in FIG. 4, or by using a simple error minimization algorithm. This optimization is univariate, i.e. only one parameter needs to be determined. When this is done, we have C(k)=a*(k−k0)=a*k−a*k0=a*k−b, which is the equation proposed above.

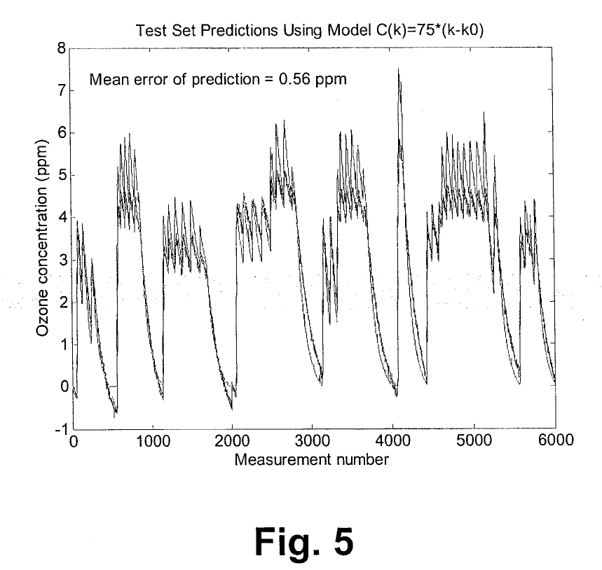

4. FIG. 4 shows training data only. To show the usefulness of the model and not only the information content of the k-values in this particular case one must test the model C(k)=a*k−b, with the value of a found above, on a totally new set of measurements, i.e. a test set. This has been done in FIG. 5.

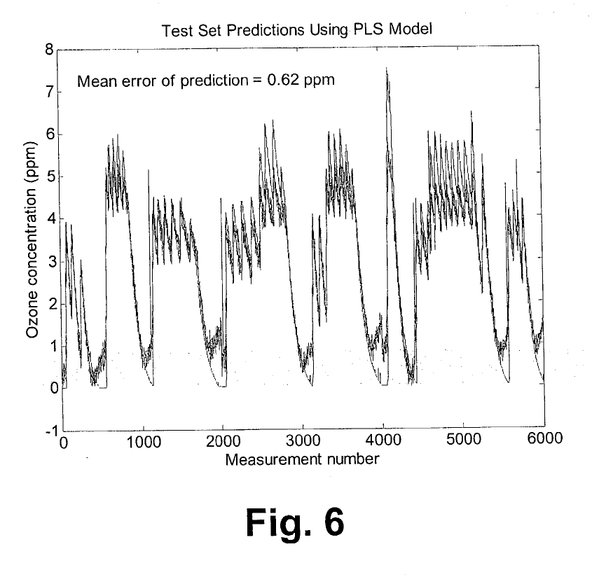

5. How good is the test set result above? To answer this question, one can compare with the corresponding result of a multivariate method, such as PLS (Partial Least Squares).This was done by making a PLS model on the same training measurements as above, and then letting this PLS model predict the values of the above test set measurements. The result is presented in FIG. 6. A comparison of the average errors of prediction (RMSEP) between the two modelling procedures, 0.56 ppm and 0.62 ppm respectively, shows that their performances are roughly the same.

The steps 1-5 have also been performed with alternative preprocessing solutions C(I)=a*I+b and C(A)=a*A+b with comparable results, where I is the integral under a selection of the curve and A is the (average) amplitude of certain points. (Note: k and A are more noise sensitive and thus require more pulses for averaging than I.)

The method is implemented by means of a computer program product comprising the software code means for performing the steps of the method. The computer program product is run on a computer or a micro processor connected to or integrated in a voltammetric apparatus. The computer program is loaded directly or from a computer usable medium, such as a floppy disc, a CD, the Internet etc

To summarize the model training and validation in this practical example, one can say that the training phase is univariate since all that needs to be optimized is the constant a, and that the testing phase is univariate, too, as k (or I, or A) is the only variable remaining after the preprocessing of the raw data. Consequently, this example shows that in accordance with the present invention, simple linear models are used successfully in pulse voltammetry instead of models brought about by multivariate methods.

1. A method of signal processing for voltammetry, comprising
applying a voltage function to a voltammetric system;
registering a current response from said system;
selecting at least one subset of said current response;
preprocessing the selected subset to extract a feature;
customizing a univariate mathematical model for the extracted feature of the selected and preprocessed subset of the response signal, using said feature as input to the model;
optionally combining several such models from different selected parts of the response; and
evaluating the model to obtain the final output.

2. The method according to claim 1, wherein the mathematical model is defined by the following equation:
$$C ( X ) = {\sum }_{i = 1}^{n} {w}_{i} \cdot {f}_{i} ( {g}_{i} ( X ) ) \qquad ( 1 )$$
wherein
X=vector of raw data from a measurement;
each i denotes a class of sample data selected from the current response obtained from the applied voltage function;
gᵢ is a function that selects a class i from the current response and pre-treats the data such that a desired feature is extracted;
fi is a function that correlates the feature (its value) selected by gᵢ to the concentration of the analyte in the sample;
n=number of terms in the sum, i.e. the number of classes or selections, according to the definition above;
Σ is a sum where i is from 1 to n;
C=concentration function, scalar output, i.e. the measured concentration.

3. The method as claimed in claim 1 or 2, wherein information about the quantity or quality to be measured is extracted from the response data by calculating the slopes or the integral between certain sampling points.

4. The method as claimed in claim 1, 2 or 3, wherein the voltage function is made repetitive so as to comprise a plurality of approximately identical parts, whereupon averages of the sections of interest of said approximately identical parts are calculated before entering the mathematical model, in order to obtain greater signal stability by noise reduction.

5. The method as claimed in claim 4, wherein the function comprises a plurality of pulses applied in a pulse train.

6. The method as claimed in claim 5, wherein at least two pulses in said pulse train have the same amplitude.

7. The method as claimed in claim 5 or 6, wherein the pulse trains are applied periodically.

8. The method as claimed in any preceding claim, wherein the voltage function is selected from a sine function, saw-tooth function, or a pulse function.

9. A voltammetric system, comprising
at least one working electrode;
a counter electrode;
a potentiostat coupled to the electrodes and capable of applying a voltage function over at least two electrodes; and
a data processing unit, programmable to perform the method comprising the steps of:
applying a voltage function to a voltammetric system;
registering a current response from said system;
selecting at least one subset of said current response;
preprocessing the selected subset to extract a feature;
customizing a univariate mathematical model for the extracted feature of the selected and preprocessed subset of the response signal, using said feature as input to the model;
optionally combining several such models from different selected parts of the response; and
evaluating the model to obtain the final output.

10. A computer program product directly loadable into the internal memory of a processing means within a computer or a micro processor connected to or integrated in a voltammetric apparatus, and comprising the software code means for performing the steps of any of the claims 1-8.

11. A computer program product stored on a computer usable medium, comprising readable program for causing a processing means in a computer or a micro processor connected to or integrated in a voltammetric apparatus, and comprising the software code means for performing the steps of any of the claims 1-8.
